(19) United States
(12) Patent Application Publication
(10) Pub. No.: US 2015/0093315 A1
(43) Pub. Date: Apr. 2, 2015

(54) Tunable AIG for Improved SCR Performance

(71) Applicants: Jeffrey Michael Broderick, Ridgefield, CT (US); Scott H. Lindemann, Oxford, CT (US); R. Gifford Broderick, Wilton, CT (US); Edmund S. Schindler, Fairfield, CT (US); James M. Valentine, Fairfield, CT (US)

(72) Inventors: Jeffrey Michael Broderick, Ridgefield, CT (US); Scott H. Lindemann, Oxford, CT (US); R. Gifford Broderick, Wilton, CT (US); Edmund S. Schindler, Fairfield, CT (US); James M. Valentine, Fairfield, CT (US)

(21) Appl. No.: 14/500,358

(22) Filed: Sep. 29, 2014

Related U.S. Application Data
(60) Provisional application No. 61/883,849, filed on Sep. 27, 2013.

(51) Int. Cl. B01D 53/90

(52) U.S. Cl. CPC B01D 53/90; B01D 2251/2062
USPC 423/239.1; 423/210; 422/105

(57) ABSTRACT

A system for controlling reagent flow to an exhaust of a lean burn combustion source includes a plurality of decomposition ducts each being connected to at least one injection lance of a reagent injection grid and supplying reagent and hot carrier gas to the injection lance, and at least one metering valve in communication with each of the plurality of decomposition ducts that controls reagent injection rate to the injection lance. A method of controlling a reagent flow to an exhaust of a lean burn combustion source includes providing a reagent injection grid having at least one injection lance, supplying the reagent and hot carrier gas to the reagent injection grid from a plurality of decomposition ducts coupled to the injection grid, and controlling reagent injection rate to the injection grid via at least one metering valve in communication with each of the plurality of decomposition ducts.

### FIELD OF THE INVENTION

The present invention relates generally to the reduction of oxides of nitrogen (NOx) emissions produced by lean burn combustion sources. In particular, the present invention provides a system and method for controlling the reagent flow to the exhaust of a lean burn combustor equipped with a NOx reduction catalyst and reagent injection grid, wherein the reagent injection rate to individual lances or groups of lances of the reagent injection grid is controlled by one or more metering valves affixed to the duct supplying hot carrier gas to the reagent injection grid.

### BACKGROUND OF THE INVENTION

Selective Catalytic Reduction (“SCR”) processes have been widely applied to boilers and gas turbines for the reduction of nitrogen oxide emissions. Traditional reagents used in the process include anhydrous ammonia and aqueous based solutions of ammonia or urea. The use of aqueous based solutions generally requires that the ammonia or urea be vaporized to a gas for injection into the primary exhaust duct through a header feeding multiple injection lances inserted through the exhaust duct wall and into the path of flowing exhaust gases at a location upstream from the SCR catalyst. Each lance typically contains multiple reagent outlet ports allowing the reagent to be dispersed in the primary exhaust gas as it flows by the lances. In addition, with aqueous solutions of urea, the urea must also be decomposed to ammonia gas so that byproducts of urea decomposition do not form deposits in the injection grid or on the downstream catalyst surfaces.

There have been several attempts to overcome the disadvantages of known urea based nitrogen oxide reduction systems. For example, U.S. Pat. No. 7,815,881 to Lin et al. describes the use of a flue gas bypass duct for injection of urea and for conversion to ammonia for SCR. U.S. Pat. No. 7,090,810 to Sun et al. describes the reduction of NOx from large-scale combustors by injecting urea into a side stream of gases with temperature sufficient for gasification and a residence time of 1-10 seconds.

However, the patents of Lin and Sun are directed at large utility boilers. Utility boilers normally have sufficient heat input, flue gas temperatures and furnace residence times to generate 50 MW or more of electric power and are typically rated at 100 MW-800 MW or more. Whereas most industrial commercial boilers are rated below 300 million Btu/hour heat input, or roughly 30 MW equivalent.

Safety concerns are leading to interest in applying aqueous urea reagents in lieu of ammonia based reagents. Urea decomposes to ammonia under temperatures above 450 F. Urea can be injected directly into the exhaust duct from wall-mounted injectors on small combustion units with low exhaust flows. For example, U.S. Pat. No. 8,815,196 to Jangiti et al. discloses a preferred method for positioning injectors on a duct wall using CFD modeling techniques. However, on large ducts, or for exhaust gas flows with high velocities, or for low temperature applications, the distribution and decomposition of urea based reagent poses challenges when injected from the exhaust duct wall.

Commonly owned U.S. Pat. No. 8,815,197 to Broderick et al. and U.S. Pat. No. 8,591,849 to Valentine et al. describe methods for decomposing aqueous urea reagent to ammonia. The output from a urea decomposition duct is routed to a traditional type ammonia injection grid (“AIG”) where the injection lances and outlet ports have been sized to handle the hot carrier gas volume containing the ammonia resulting from the decomposition of urea. The decomposed and vaporized reagent is injected from the AIG into the primary exhaust upstream of a catalyst. These patents are generally directed at smaller combustion sources where a single continuous decomposition duct is adequate for the decomposition of the aqueous based reagent that is generally introduced at a rate of less than 10 gallons per hour (“gph”).

U.S. patent application Ser. No. 14/045,449 to Broderick et al. discloses the use of a decomposition duct for converting urea to ammonia in an SCR system located in a heat recovery steam generator and cites an example of injecting 7 gph. While the application cites a plurality of decomposition ducts each with an injector, it is does not disclose the individual control of reagent at different injection rates in each of the decomposition ducts, nor does it disclose the potential need to inject higher volumes of reagent beyond 10 gph.

U.S. patent application Ser. No. 10/254,192 to Buzanowski, now abandoned, describes an AIG arrangement with distribution lances having 3/16 inches diameter holes for injecting vaporized aqueous ammonia. Buzanowski discloses adjusting the ammonia injection rate through the lances using electrically controlled tuning valves positioned near where the lance penetrates the primary exhaust gas duct. In the system of Buzanowski, the ability to control the quantity of ammonia to any particular lance is by using the tuning valves to control the quantity of blended hot carrier gas and reagent to each lance. As a result, the ammonia concentration in the carrier gas from the vaporizer is common to all elements of the AIG. Buzanowski identifies the need for the ability to tune the injection rate to match imbalances in NOx, velocity or gas flow at the catalyst and does so by adjusting the blended gas flow rate through each AIG lance. This has the disadvantage of changing the velocity of the gas flowing through the lance and hence the penetration of the reagent into the primary exhaust gas stream. It may also lower the temperature of the lance as the gas flow is reduced potentially leading to the formation of deposits in the lance especially when using urea-based reagent. Buzanowski does not propose maintaining gas flow through the lances and adjusting the quantity or concentration of reagent in the carrier gas delivered to any AIG lance or section of lances as a method of tuning. Nor does it disclose independently varying the carrier gas flow to each lance, or section of lances, and separately varying the flow of reagent to the lances.

Buzanowski points out that plugging of the AIG holes can result at low temperatures from the formation of ammonium salts in reaction with sulfur tri-oxide (SO₃) from the flue gas. The potential for plugging inside the AIG lances with urea-based systems also results from the deposition of urea decomposition products and deposit formation in the AIG. Maintaining temperature and mass flow of carrier gas through the AIG is important in reducing the formation of urea deposits in the AIG. It would be desirable to be able to adjust the ammonia concentration at an individual lance or section of the AIG while still maintaining the hot carrier gas flow rate and temperature through all the AIG lances to minimize the potential for deposit formation in the lances and outlet ports.

In U.S. Pat. No. 7,166,262, Buzanowski again discloses controlling the injection of reagent and carrier gases to an AIG by again using motorized ammonia flow control valves to control the blended flow of reagent and carrier gases to individual sections of the AIG. As described above, this has the effect of also changing the hot gas flow rate through a section of the AIG which in turn impacts residence time, velocity and temperature through the section of lances and can lead to deposit formation in the lances.

Therefore, it would be advantageous to provide a system and method for individual control of reagent at different injection rates in each of the decomposition ducts, wherein the reagent is able to be injected at higher volumes of beyond 10 gph. It would also be advantageous to provide a system and method for adjusting the ammonia injection rate without changing the residence time, velocity and temperature of the gas flowing through the lance or section of the AIG. It would further be desirable to be able to adjust the ammonia concentration at an individual lance or section of the AIG while still maintaining the hot carrier gas flow rate and temperature through all the AIG lances to minimize the potential for deposit formation in the lances and outlet ports. In other cases, it is desirable to have the flexibility to separately control the air flow to each section of the AIG and separately control the reagent flow to each section of the AIG.

### SUMMARY OF THE INVENTION

It is an objective of the present invention to provide a system and method for individual control of reagent at different injection rates in each of the decomposition ducts, wherein the reagent is able to be injected at higher volumes of beyond 10 gph.

It is also an objective of the present invention to provide a system and method for adjusting the reagent injection rate without changing the residence time, velocity and temperature of the gas flowing through the lances.

It is further an objective of the present invention to provide a system and method for adjusting the reagent concentration at an individual lance or section of the AIG while still maintaining the hot carrier gas flow rate and temperature through all the AIG lances to minimize the potential for deposit formation in the lances and outlet ports.

It is yet further an objective of the present invention to provide a system and method with enhanced flexibility for tuning the injection rate by maintaining gas flow through the lances and adjusting the quantity or concentration of reagent in the carrier gas delivered to any AIG lance or section of lances and by independently varying the carrier gas flow to each lance, or section of lances, and separately varying the flow of reagent to the lances.

These and other objectives are achieved by providing a system for controlling a reagent flow to an exhaust of a lean burn combustion source equipped with a catalyst, including a plurality of decomposition ducts, wherein each decomposition duct is connected to at least one injection lance of a reagent injection grid and supplies reagent and hot carrier gas to the at least one injection lance, and at least one metering valve in communication with each of the plurality of decomposition ducts, wherein the at least one metering valve controls reagent injection rate to the at least one injection lance of the injection grid.

In some advantageous embodiments, each of the plurality of decomposition ducts feeds a plurality of injection lances of the reagent injection grid. In additional advantageous embodiments, the plurality of decomposition ducts connect to a common header that supplies a mixture of hot gas and vaporized reagent to the reagent injection grid. In further advantageous embodiments, each of the plurality of decomposition ducts is connected to one injection lance, and the individual lances receive hot carrier gas from a supply header connected to inlet ends of the plurality of decomposition ducts.

In some embodiments, each of the plurality of decomposition ducts has two or more metering valves in communication with the decomposition ducts.

In certain embodiments, the hot carrier gas supplied to the reagent injection grid is exhaust gas. In additional embodiments, the hot gas supplied to the reagent injection grid is ambient air heated by a supplemental heater. In some of these additional embodiments, the supplemental heater is at least one of an electric heater, heat exchanger and burner.

In some embodiments, the injection rate to the at least one decomposition duct is between about 0.2 and about 40 gallons per hour of aqueous reagent.

In some cases, a residence time from a point of reagent injection in the decomposition ducts to an outlet of the injection grid is less than 1 second.

In certain embodiments, the hot carrier gas flow to the plurality of decomposition ducts feeding the reagent injection grid is controlled by at least one flow control valve positioned in each of the plurality of decomposition ducts upstream of the at least one metering valve. In some of these embodiments, the at least one flow control valve is manually adjusted. In additional of these embodiments, the at least one flow control valve is automatically adjusted.

In some embodiments, the system further includes a fan connected to the plurality of decomposition ducts and the hot carrier gas flow is regulated by a variable frequency drive coupled to the fan. In additional embodiments, the system further has a fan connected to the plurality of decomposition ducts and the hot carrier gas flow is regulated by a damper positioned at an outlet of the fan.

In some advantageous embodiments, the injection grid has a plurality of injection lances and the plurality of injection lances flow the same injection rate of the carrier gas, the reagent or a blend thereof at any given operating condition of the combustion source. In additional advantageous embodiments, the injection grid has a plurality of injection lances and at least one of the plurality of injection lances flows a different rate of injection of the carrier gas, the reagent or a blend thereof at any given operating condition of the combustion source.

In certain embodiments, the reagent is urea, and the carrier gas flow rate and gas temperature in the plurality of decomposition ducts before a point of reagent injection are maintained so that a gas temperature of a blended flow after the reagent injection is maintained at about 600 F or greater at an inlet to the reagent injection grid. In additional embodiments, the reagent is aqueous ammonia, and the hot carrier gas flow rate and gas temperature in the plurality of decomposition ducts before a point of reagent injection are maintained so that a gas temperature of a blended flow after the reagent injection is maintained at greater than about 250 F at an inlet to the reagent injection grid.

In some cases, the at least one metering valve is a pulse width modulated solenoid valve. In additional embodiments, the at least one metering valve is a variable speed chemical feed pump.

In some cases, the at least one metering valve atomizes the reagent such that it is injected into the decomposition ducts with droplet sizes between about 10 microns and about 70 microns.

In certain embodiments, the system further includes at least one sensor positioned in a primary exhaust duct after a catalyst chamber, and a quantity of the reagent injected into the plurality of decomposition ducts is based at least in part on a measurement of at least one of NOx concentration and ammonia slip received from the at least one sensor.

In some embodiments, the system further includes at least one atomizer affixed to each of said plurality of decomposition ducts for supplying atomized reagent to the decomposition ducts. In certain of these embodiments, the at least one atomizer and the at least one metering valve are formed as an integral unit that defines an atomizing injector.

A system for controlling a reagent flow to an exhaust of a lean burn combustion source equipped with a catalyst is also provided, including a reagent injection grid, at least one decomposition duct coupled to the reagent injection grid, wherein the at least one decomposition duct supplies reagent and hot carrier gas to the reagent grid, and a plurality of metering valves in communication with the at least one decomposition duct, wherein the plurality of metering valves control reagent injection rate to the injection grid.

A method of controlling a reagent flow to an exhaust of a lean burn combustion source equipped with a catalyst is further provided, including the steps of providing a reagent injection grid comprising at least one injection lance, supplying the reagent and hot carrier gas to the reagent injection grid from a plurality of decomposition ducts coupled to the reagent injection grid, and controlling reagent injection rate to the injection grid via at least one metering valve in communication with each of the plurality of decomposition ducts.

In some advantageous embodiments, each of the plurality of decomposition ducts feeds a plurality of injection lances of the reagent injection grid. In additional advantageous embodiments, the plurality of decomposition ducts connect to a common header that supplies a mixture of hot gas and vaporized reagent to the reagent injection grid. In further advantageous embodiments, each of the plurality of decomposition ducts is connected to an injection lance, and the hot carrier gas is supplied to the individual lances from a supply header connected to the plurality of decomposition ducts at a position upstream of the metering valve.

In certain embodiments, each of the plurality of decomposition ducts has two or more metering valves in communication with the decomposition ducts.

In some embodiments, the hot carrier gas supplied to the reagent injection grid is exhaust gas. In other embodiments, the hot carrier gas supplied to the reagent injection grid is ambient air and the method further includes the step of heating the ambient air by a supplemental heater before it is supplied to the reagent injection grid.

In certain embodiments, the reagent is injected to the at least one decomposition duct at a rate between about 0.2 and about 40 gallons per hour of aqueous reagent.

In some embodiments, the method further includes the step of controlling the hot carrier gas flow to the plurality of decomposition ducts feeding the reagent injection grid via at least one flow control valve positioned in each of the plurality of decomposition ducts upstream of the at least one metering valve.

In certain advantageous embodiments, the injection grid includes a plurality of injection lances and the plurality of injection lances flow the same injection rate of the carrier gas, the reagent or a blend thereof at any given operating condition of the combustion source. In additional advantageous embodiments, the injection grid has a plurality of injection lances and the plurality of injection lances flow a different rate of injection of the carrier gas, the reagent or a blend thereof at any given operating condition of the combustion source.

In some embodiments, the reagent is urea, and the method further includes the step of setting the carrier gas flow rate and gas temperature in the plurality of decomposition ducts before a point of reagent injection such that a gas temperature of a blended flow after the reagent injection is maintained at about 600 F or greater in the reagent injection grid. In additional embodiments, the reagent is aqueous ammonia, and the method further includes the step of setting the hot carrier gas flow rate and gas temperature in the plurality of decomposition ducts before a point of reagent injection such that a gas temperature of a blended flow after the reagent injection is maintained at greater than about 250 F in the reagent injection grid.

In certain embodiments, the method further includes the step of measuring at least one of NOx concentration and ammonia slip via at least one sensor positioned in a primary exhaust duct after a catalyst chamber, wherein a quantity of the reagent injected into the plurality of decomposition ducts is based at least in part on the measurements received from the at least one sensor.

In some embodiments, a residence time from a point of reagent injection in the decomposition ducts to an outlet of the injection grid is less than 1 second.

Other objects of the invention and its particular features and advantages will become more apparent from consideration of the following drawings and accompanying detailed description.

### BRIEF DESCRIPTION OF THE DRAWINGS

FIG. 1 is a schematic view of an injection system in accordance with the present invention, with three decompositions ducts each having a plurality of injection lances coupled thereto.

FIG. 2 is a schematic view of an injection system in accordance with the present invention, with three decompositions ducts connecting to a common duct with a plurality of injection lances coupled to the duct.

FIG. 3 is a schematic view of an injection system in accordance with the present invention, with multiple decompositions ducts each having one injection lance coupled thereto.

### DETAILED DESCRIPTION OF THE INVENTION

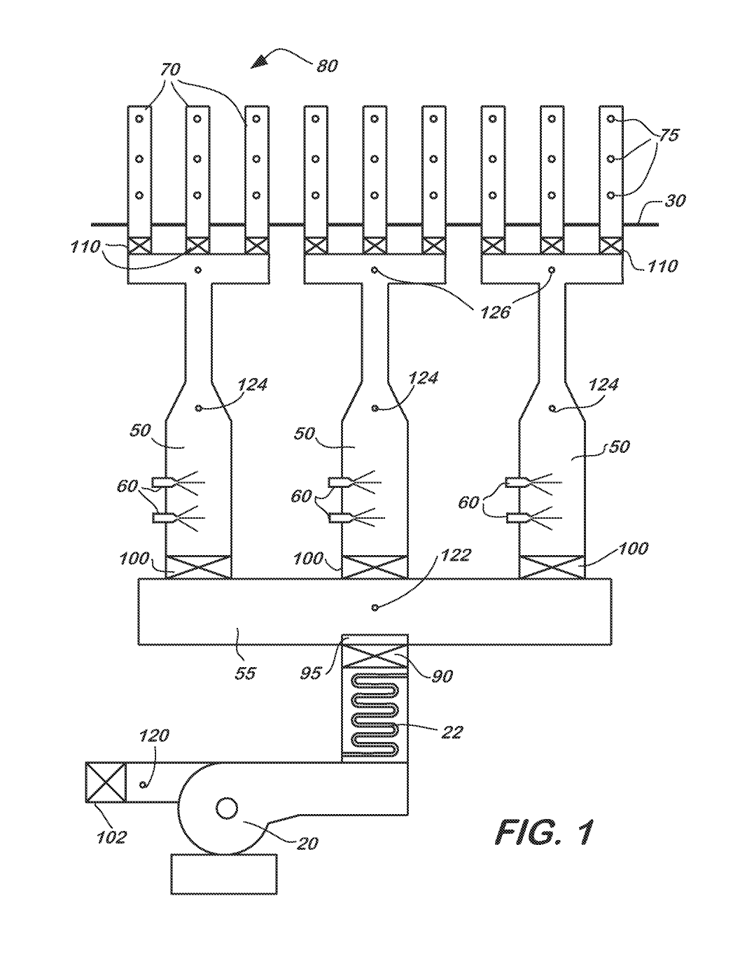

In one exemplary embodiment illustrated in FIG. 1, the current invention provides a plurality of continuous urea decomposition ducts (50) connected to individual AIG injection lances (70), or AIG sections of multiple injection lances. On each decomposition duct (50), a single or multiple aqueous reagent injectors or atomizers (60) with metering valves are mounted to allow control of the reagent injection rate separately from that of the hot carrier gas flow. In some advantageous embodiments, one or more metering valves and an atomizer are formed as an integral unit that defines an atomizing injector. A return flow injector, as described in U.S. Pat. No. 7,467,749, the specification of which is incorporated herein in its entirety, is particularly suitable for this application. In additional advantageous embodiments, an air assisted injection lance with a metering valve may be used, such as described in pending U.S. patent application Ser. No. 13/313,683, the specification of which is incorporated herein in its entirety, for metering, atomization and cooling of the reagent. In some embodiments, the metering valves may be positioned remotely from and fluidly connected to the atomizing injector and/or air assisted injector lance mounted on the decomposition ducts (50) that atomize the reagent. It is understood that the references to the injector (60) in the specification are intended to encompass any of the suitable injector/metering valve configurations discussed above.

In some embodiments, the metering valve is a pulse width modulated solenoid valve. In additional embodiments, the metering valve is a variable speed chemical feed pump.

The use of multiple decomposition ducts allows for a higher total injection rate than the cited prior art while also providing better control over the gas temperature downstream of the reagent injection point by limiting the injection rate to any one decomposition duct and reducing pooling of liquid reagent in the duct.

In the present invention, hot exhaust gas or heated air is supplied to each decomposition duct from a fan or blower (20). A supplemental heater (22), including an electric heater, gas or oil fired burner, or heat exchanger, may be used and may be positioned before or after the fan to achieve the desired temperature of the carrier gas flowing to the decomposition ducts. The fan or blower may feed a common carrier gas header connected to all or several of the decomposition ducts, or individual fans can be connected to individual decomposition ducts.

The aqueous reagent injection rate to each decomposition duct is controlled by a programmable logic controller (“PLC”) based controller or any other suitable controller as a function of: combustor load, fuel flow rate, exhaust gas flow rate, decomposition gas flow rate and/or temperature, NOx concentration before or after the catalyst, ammonia slip past the SCR catalyst or any combination of those sensor measurements. The injection rate can be adjusted to provide the necessary quantity of reagent to an individual injection lance, or section of lances, of the AIG to achieve the desired emissions past the catalyst.

In one advantageous embodiment of the present invention, the temperature and mass flow rate of hot carrier gas through each injection lance, or section of injection lances, is maintained, and only the concentration of reagent in the carrier gas through a particular decomposition duct is changed by a control signal to the injector mounted on that specific decomposition duct. This allows precise tuning of the reagent injection through the injection lance or a section of the AIG while maintaining the carrier gas flow rate and temperature through the injection lance. Imbalances in NOx emissions across the primary exhaust can now be addressed by tuning the injection rate of reagent to each continuous decomposition duct and its associated injection lance, or section of lances, in the AIG arrangement. Further, tuning can be accomplished if desired by manual or automatic tuning valves (110) at each injection lance or by varying the speed of the fan (20) providing carrier gas to the decomposition ducts (50).

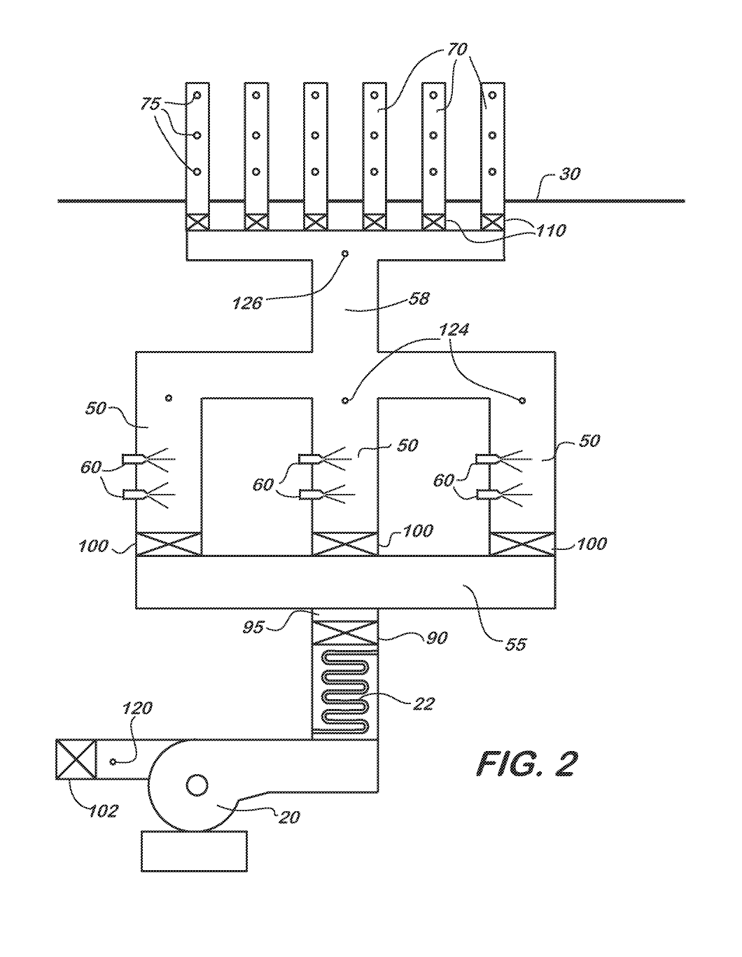

In the embodiment shown in FIG. 1, the traditional ammonia flow control unit or decomposition reactor is replaced by a plurality of decomposition ducts (50) each with at least one injector (60) mounted on it to introduce reagent into the hot carrier gas flow through the decomposition ducts. The outlet of an individual decomposition duct may be tied to a lance or section of lances on an AIG. In other simplified arrangements, such as shown in FIG. 2, the outlets of the individual decomposition ducts (50) can be connected by a common header (58) to feed multiple injection lances (70) of the AIG.

Hot gas flow to each decomposition duct (50) is typically designed for 300 to 1500 actual cubic feet per minute (“acfm”) per gallon of 32.5% aqueous solution of urea injected at a gas temperature of 600-950 F. In certain advantageous embodiments, hot gas flow to the decomposition duct is 600-1000 acfm at 750-800 F for each gallon of aqueous urea reagent injected into the decomposition duct. The flow rate and temperature of the carrier gas can be adjusted within these parameters for higher or lower concentrations of urea solution (25-50%) with the objective of maintaining a temperature above 650 F in the decomposition duct after the point of reagent injection and typically a temperature of greater than 600 F at the AIG when using urea.

When using a 19% solution of aqueous ammonia, for example, the hot gas flow rate can be reduced to a range of 40-150 acfm per gallon of aqueous ammonia reagent at a temperature of 700 F, and the temperature after injection is preferably maintained above 250 F in the decomposition duct after the point of injection. This is because the decomposition of aqueous ammonia proceeds quicker and more completely at lower temperatures versus aqueous urea.

Urea reagent solution is typically injected into each of a plurality of decomposition ducts at the rate of about 0.5-15 gph and preferably about 3-10 gph. In some cases, a cyclonic duct for reagent decomposition may be used. The reagent is introduced into the larger diameter mixing duct through an injection lance enclosed in a smaller diameter shroud located at the inlet end of the mixing duct. Heated gas, comprising air or combustion gases, enters the mixing duct in a tangential fashion that imparts a cyclonic rotation to the hot gases around the injector shroud and down the length of the mixing duct. The cyclonic flow of hot gases serves to effectively heat the walls of the mixing duct in the area of injection and assists in evaporating and decomposing the aqueous reagent to ammonia gas. It also serves to “scrub” the walls of any liquid reagent or byproducts of reagent decomposition. The scrubbing action, in conjunction with maintaining the chamber walls above a critical temperature, tend to minimize deposit formation on the walls. When a cyclonic duct is used, the rate of injection can be significantly increased to about 20-30 gph and even as much as about 40 gph for the same hot gas flow rate.

When introduced into the flowing hot gas at the temperatures prescribed above, the urea solution is decomposed into ammonia gas before reaching the AIG. Each decomposition duct is connected to at least one distribution lance of the AIG or it may feed multiple distribution lances forming a section of the AIG. The AIG is placed in the primary exhaust duct upstream of an SCR catalyst. The decomposition duct is sized in diameter and length to achieve a residence time of less than 1 second from the point of urea injection in the decomposition duct to the introduction of the ammonia gas into the primary exhaust duct of the combustor. In one advantageous embodiment, the preferred residence time is about 0.8 seconds and decomposition duct diameter is about 12 to 36 inches, depending on the volume of hot carrier gas and the quantity of urea injected.

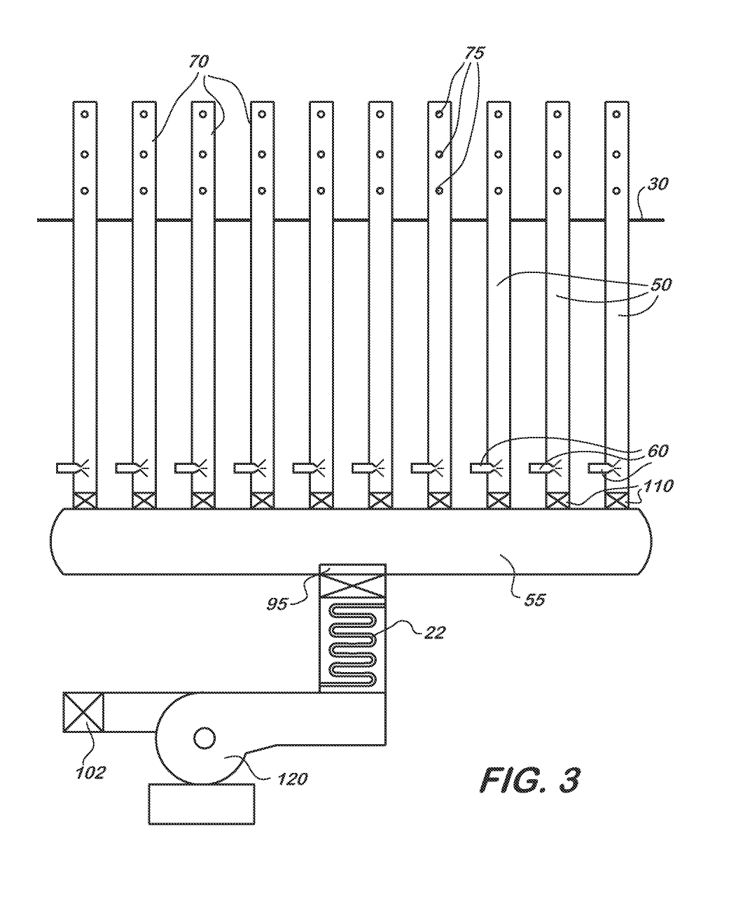

In certain additional embodiments, as shown in FIG. 3, it may be advantageous to use multiple decomposition ducts (50) that are less than about 12 inches in diameter, for example, from about 3 inches to about 10 inches in diameter. There may be as many as 10-20 individual ducts, or even as many as 24-60 ducts. Each of these decomposition ducts is connected to at least one injection lance (70) that penetrates the primary exhaust duct wall (30) and introduces ammonia gas into the primary exhaust gas stream. These decomposition ducts (50) are fed hot carrier gas from a hot gas header that is supplied by a fan (20) and a heater (22), or alternatively the header is provided with hot exhaust gas. Each of the decomposition ducts (50) receiving hot carrier gas has an individual reagent injector (60) mounted on the duct that is used to control the rate of reagent injection into the duct based on a control signal from a programmable logic controller. The decomposition ducts can be equipped with manual or automatic dampers or control valves located upstream of the reagent injection point to regulate the flow of hot carrier gas to the duct based on the quantity of reagent being injected, or the airflow to each duct can be kept the same and the total air flow adjusted by a damper at the fan or by using a variable speed fan. The residence time in each decomposition duct is preferably maintained at less than about 1 second from the point of reagent injection to the AIG outlet orifice (75).

In some advantageous embodiments, the hot gas flow through the decomposition duct is maintained at a constant flow rate and temperature to help maintain the temperature of the AIG lances and to minimize the potential for deposits to plug the AIG outlet holes. In additional advantageous embodiments, the hot gas flow rate is varied to individual decomposition ducts using a flow control valve (110) to match a changing urea injection rate. The urea injection rate is controlled by the reagent controller to meet NOx reduction targets, or ammonia slip targets, at different loads or when firing different fuels or when operation of other NOx reduction techniques (water or steam injection, SNCR or over fire air) are used in combination with SCR such that the urea injection rate can be reduced. A reagent controller, such as the TRIM-NOX® injection system manufactured by CCA Combustion Systems of Monroe, Conn., is well suited for the control of the reagent injection rate based on signals regarding combustor load, exhaust gas flow rate, temperature in the decomposition duct, fuel flow, or exhaust emissions. It is understood, however, that any other suitable reagent controller may also be used in accordance with the present invention.

The use of dedicated injectors on individual decomposition ducts allows for precise tuning of the reagent injection rate on each decomposition duct and its corresponding injection lance or section of the AIG. The current invention allows precise tuning of reagent injection to match NOx distribution across the duct. NOx concentrations across the primary exhaust duct can vary as a result of load changes, fuel changes, gas flow imbalances or other operating conditions in the boiler, gas turbine or heat recovery sections.

For example, in the case of a large gas turbine SCR, the maximum required reagent flow rate is 60 gph of 32% urea solution at full load. Six individual decomposition ducts of about 32 inches diameter are provided with a slipstream of hot exhaust gas flow of 10,000 acfm/duct at a temperature of at least 700-750 F. A fan and heater are provided to maintain the gas pressure and temperature through the decomposition duct and AIG.

FIG. 1 shows an example where a fan (20) and heater (22) are common to three of the six decomposition ducts (50) fed by a common hot gas header (55), but it is understood that each duct may have a dedicated fan and/or heater if desired. Each decomposition duct is fitted with two solenoid actuated pulse width injectors (60) that precisely control the rate and droplet size of urea injection into the individual decomposition ducts. Urea solution is supplied to the injectors by a reagent pumping system from a bulk storage tank (not shown). A target injection rate at full load on the combustor is about 10 gph/duct; however, the injectors are each capable of injecting up to 8 gph for a total of 16 gph/duct. The rate of reagent injection can be varied by controlling the injectors (60) on each duct and the corresponding carrier gas flow through the decomposition duct can be adjusted up or down by adjustable dampers at the inlet to the decomposition duct (100) or by a damper at the outlet of the fan (90) or by adjusting the speed of the fan (20).

Computational fluid dynamics modeling or measurement of NOx in the duct upstream of the catalyst can be used to determine the required reagent injection rate. Alternatively, or in combination, downstream sampling of NOx or reagent concentration across the duct using a portable analyzer is used to develop an injection map for the rate of injection versus combustor load or fuel flow or other operating condition. In some cases, a real time measurement of the exhaust gas downstream of the SCR catalyst chamber is used to adjust the injection rate based on a target NOx and/or ammonia slip. Single or multiple sensors across the duct may be used for measurement and a tunable diode laser with multiple detection points across a duct that are operated in a sequencing mode may also be used as a control signal to the injection rate controller. These sensors are generally positioned downstream of the SCR catalyst chamber where the primary gas flow is well mixed after passing through the SCR catalyst.

Duct length is established to provide a residence time from the point of urea injection to the AIG injection port of about 0.6-0.8 seconds. Alternatively, a 24 inch diameter duct may be used with an adjustment in length to maintain the same residence time. Each decomposition duct (50) is connected to at least one AIG injection lance (70) installed in the primary exhaust duct (80) upstream of the SCR catalyst. Each lance (70) is fitted with multiple outlet orifices (75). At lower loads, when the reagent injection rate is lower, the gas flow rate to each decomposition duct is preferably maintained to maintain the residence time of about 0.6-0.8 seconds. The urea injection rate on a given decomposition duct is adjusted by the controller to achieve the targeted NOx reduction and/or minimum ammonia slip past the catalyst as measured by downstream portable or fixed sensors or on the basis of a previously determined injection rate map.

The injection rate for any given combination of load, fuel, emissions or operating condition may be programmed into the controller to automatically adjust the injection rate to individual decomposition ducts to meet an overall NOx emission or ammonia slip target. The injection rate on the decomposition ducts (50) may be the same or may be different across the individual decomposition ducts. To assist with transient control, turn down or operating efficiency, the carrier gas flow rate to each decomposition duct, or the bulk gas flow rate to multiple ducts, may be controlled by adjusting a damper at the fan outlet (90) or by varying the speed of the fan (20) or by other flow control valves (100) at the inlet to the decomposition ducts. A flow measurement device (95) at the fan outlet is used to monitor total hot gas flow and provides input to the controller to adjust fan speed or damper position.

Additionally, for fine tuning of the injection through the AIG, the blended gas and reagent flow from the decomposition duct through a section of the AIG is controlled by manual or automated tuning valves (110) at the lances (70). A plurality of thermocouples are used to monitor temperatures and adjust the gas flow rate and supplemental heater (22) to maintain the targeted temperature in the decomposition duct outlet and at the AIG above the target temperature. The thermocouples includes thermocouples (120) positioned at the inlet to the fan (120), thermocouples (122) positioned at the common hot gas header, thermocouples (124) positioned in the decomposition ducts and/or thermocouples (126) positioned at the AIG lances. It is understood that any of the above thermocouples or any combinations thereof may be used. It is also understood that thermocouples may also be positioned at any other suitable location.

FIG. 2 illustrates one half of the injection system for a large turbine SCR, wherein the outlet flows of three of the total six decomposition ducts (50) are connected to a common header (58), which then feeds multiple AIG lances (70) or sections of the AIG representing half of the AIG reagent injection capacity. In this example, each of two headers (58) is fed by three decomposition ducts (50) at a nominal hot gas flow rate of 30,000 acfm per header. One header runs up one side of the primary exhaust duct and feeds multiple AIG pipes, or half of the AIG, while the other header fed by three decomposition ducts feeds the other half of the AIG on the other side of the exhaust duct. The overall residence time from the point of urea injection into the decomposition ducts to introduction of ammonia gas into the primary exhaust duct is less than about 1 second. The use of multiple ducts helps to avoid the quenching of the carrier gas temperature or the physical pooling of reagent in the duct that can occur when introducing large quantities of reagent into a single duct, such as required at high load conditions.

At lower loads, with lower total reagent injection rates and potentially lower hot gas flow requirements, one or two of the decomposition ducts may be closed using dampers (100), and the reagent injection to those ducts may be stopped. The hot carrier gas flow is then directed to the one or two operating decomposition ducts. This allows for a reduction in cumulative carrier gas flow while still maintaining residence time and temperature through the operating decomposition duct(s).

FIG. 3 illustrates an example of multiple decomposition ducts (50) that are each supplied with reagent from an individual injector (60) mounted on each duct (50). Each decomposition duct is connected to at least one injection lance (70) inserted into the primary exhaust gas stream upstream of a SCR catalyst. A common header (55) feeds the decomposition ducts with hot carrier air or exhaust gas from the hot gas fan (20) and supplemental heater (22). The heater may be electric, or a burner or heat exchanger. FIG. 3 shows ten decomposition ducts, but it is understood that fewer ducts may be used, or as many as 20-60 individual ducts may also be used, each with a dedicated injector (70).

Variable speed fans, dampers and/or control valves may also be used in combination with the present invention, if desired, to further adjust the hot carrier gas flow through the decomposition ducts and/or to the AIG lances as the urea injection rate is varied by the PLC based injection system controller.

Although the invention has been described in connection with various illustrated embodiments, numerous modifications and adaptations may be made thereto without departing from the spirit and scope of the invention as set forth in the claims.

What is claimed is:

1. A system for controlling a reagent flow to an exhaust of a lean burn combustion source equipped with a catalyst, comprising:
a plurality of decomposition ducts, wherein each decomposition duct is connected to at least one injection lance of a reagent injection grid and supplies reagent and hot carrier gas to said at least one injection lance; and
at least one metering valve in communication with each of said plurality of decomposition ducts, wherein said at least one metering valve controls reagent injection rate to said at least one injection lance of said injection grid.

2. The system of claim 1, wherein each of said plurality of decomposition ducts feeds a plurality of injection lances of said reagent injection grid.

3. The system of claim 1, wherein said plurality of decomposition ducts connect to a common header that supplies a mixture of hot gas and vaporized reagent to said reagent injection grid.

4. The system of claim 1, wherein each of said plurality of decomposition ducts is connected to one injection lance, and wherein the individual lances receive hot carrier gas from a supply header connected to inlet ends of said plurality of decomposition ducts.

5. The system of claim 1, wherein each of said plurality of decomposition ducts has two or more metering valves in communication with the decomposition ducts.

6. The system of claim 1, wherein the hot carrier gas supplied to said reagent injection grid is exhaust gas.

7. The system of claim 1, wherein the hot gas supplied to said reagent injection grid is ambient air heated by a supplemental heater.

8. The system of claim 7, wherein the supplemental heater comprises at least one of an electric heater, heat exchanger and burner.

9. The system of claim 1, wherein the injection rate to the at least one decomposition duct is between about 0.2 and about 40 gallons per hour of aqueous reagent.

10. The system of claim 1, wherein a residence time from a point of reagent injection in the decomposition ducts to an outlet of the injection grid is less than 1 second.

11. The system of claim 1, wherein the hot carrier gas flow to said plurality of decomposition ducts is controlled by at least one flow control valve positioned in each decomposition duct upstream of the at least one metering valve.

12. The system of claim 11, wherein the at least one flow control valve is manually adjusted.

13. The system of claim 11, wherein the at least one flow control valve is automatically adjusted.

14. The system of claim 1, wherein the system further comprises a fan connected to said plurality of decomposition ducts and wherein the hot carrier gas flow is regulated by a variable frequency drive coupled to the fan.

15. The system of claim 1, wherein the system further comprises a fan connected to said plurality of decomposition ducts and wherein the hot carrier gas flow is regulated by a damper positioned at an outlet of the fan.

16. The system of claim 1, wherein said injection grid comprises a plurality of injection lances and wherein the plurality of injection lances flow the same injection rate of the carrier gas, the reagent or a blend thereof at any given operating condition of the combustion source.

17. The system of claim 1, wherein said injection grid comprises a plurality of injection lances and wherein at least one of the plurality of injection lances flows a different rate of injection of the carrier gas, the reagent or a blend thereof at any given operating condition of the combustion source.

18. The system of claim 1, wherein the reagent is urea, and wherein the carrier gas flow rate and gas temperature in said plurality of decomposition ducts before a point of reagent injection are maintained so that a gas temperature of a blended flow after the reagent injection is maintained at about 600 F or greater at an inlet to said reagent injection grid.

19. The system of claim 1, wherein the reagent is aqueous ammonia, and wherein the hot carrier gas flow rate and gas temperature in said plurality of decomposition ducts before a point of reagent injection are maintained so that a gas temperature of a blended flow after the reagent injection is maintained at greater than about 250 F at an inlet to said reagent injection grid.

20. The system of claim 1, wherein the at least one metering valve comprises a pulse width modulated solenoid valve.

21. The system of claim 1, wherein the at least one metering valve comprises a variable speed chemical feed pump.

22. The system of claim 1, wherein the at least one metering valve atomizes the reagent such that it is injected into the decomposition ducts with droplet sizes between about 10 microns and about 70 microns.

23. The system of claim 1, wherein the system further comprises at least one sensor positioned in a primary exhaust duct after a catalyst chamber, and wherein a quantity of the reagent injected into said plurality of decomposition ducts is based at least in part on a measurement of at least one of NOx concentration and ammonia slip received from said at least one sensor.

24. The system of claim 1, further comprising at least one atomizer affixed to each of said plurality of decomposition ducts for supplying atomized reagent to the decomposition ducts.

25. The system of claim 24, wherein said at least one atomizer and said at least one metering valve are formed as an integral unit that defines an atomizing injector.

26. A system for controlling a reagent flow to an exhaust of a lean burn combustion source equipped with a catalyst, comprising:
a reagent injection grid;
at least one decomposition duct coupled to said reagent injection grid, wherein the at least one decomposition duct supplies reagent and hot carrier gas to said reagent grid; and
a plurality of metering valves in communication with said at least one decomposition duct, wherein said plurality of metering valves control reagent injection rate to said injection grid.

27. A method of controlling a reagent flow to an exhaust of a lean burn combustion source equipped with a catalyst, comprising the steps of:
providing a reagent injection grid comprising at least one injection lance;
supplying the reagent and hot carrier gas to said reagent injection grid from a plurality of decomposition ducts coupled to said reagent injection grid; and
controlling reagent injection rate to said at least one injection lance of said injection grid via at least one metering valve in communication with said at least one decomposition duct.

28. The method of claim 27, wherein each of the plurality of decomposition ducts feeds a plurality of injection lances of said reagent injection grid.

29. The method of claim 27, wherein the plurality of decomposition ducts connect to a common header that supplies a mixture of hot gas and vaporized reagent to said reagent injection grid.

30. The method of claim 27, wherein each of the plurality of decomposition ducts is connected to an injection lance, and wherein the hot carrier gas is supplied to the individual lances from a supply header connected to inlet ends of the plurality of decomposition ducts.

31. The method of claim 27, wherein each of said plurality of decomposition ducts has two or more metering valves in communication with the decomposition ducts.

32. The method of claim 27, wherein the hot carrier gas supplied to said reagent injection grid is exhaust gas.

33. The method of claim 27, wherein the hot carrier gas supplied to said reagent injection grid is ambient air and wherein the method further comprises the step of heating the ambient air by a supplemental heater before it is supplied to said reagent injection grid.

34. The method of claim 27, wherein the reagent is injected to the at least one decomposition duct at a rate between about 0.2 and about 40 gallons per hour of aqueous reagent.

35. The method of claim 27, further comprising the step of controlling the hot carrier gas flow to the plurality of decomposition ducts feeding said reagent injection grid via at least one flow control valve positioned in each of the plurality of decomposition ducts upstream of the at least one metering valve.

36. The method of claim 27, wherein said injection grid comprises a plurality of injection lances and wherein the plurality of injection lances flow the same injection rate of the carrier gas, the reagent or a blend thereof at any given operating condition of the combustion source.

37. The method of claim 27, wherein said injection grid comprises a plurality of injection lances and wherein the plurality of injection lances flow a different rate of injection of the carrier gas, the reagent or a blend thereof at any given operating condition of the combustion source.

38. The method of claim 27, wherein the reagent is urea, and wherein the method further comprises the step of setting the carrier gas flow rate and gas temperature in the plurality of decomposition ducts before a point of reagent injection such that a gas temperature of a blended flow after the reagent injection is maintained at about 600 F or greater at an inlet to said reagent injection grid.

39. The method of claim 27, wherein the reagent is aqueous ammonia, and the method further comprises the step of setting the hot carrier gas flow rate and gas temperature in the plurality of decomposition ducts before a point of reagent injection such that a gas temperature of a blended flow after the reagent injection is maintained at greater than about 250 F at an inlet to said reagent injection grid.

40. The method of claim 27, wherein the method further comprises the step of measuring at least one of NOx concentration and ammonia slip via at least one sensor positioned in a primary exhaust duct after a catalyst chamber, wherein a quantity of the reagent injected into the plurality of decomposition ducts is based at least in part on the measurements received from the at least one sensor.

41. The method of claim 27, wherein a residence time from a point of reagent injection in the decomposition ducts to an outlet of the injection grid is less than 1 second.
